(19) United States
(12) Patent Application Publication
(10) Pub. No.: US 2010/0141947 A1
(43) Pub. Date: Jun. 10, 2010

(54) Small Angle Light Scattering System and Method for Detecting Changes in Cell Parts

(76) Inventor: Satish Deshpande, Guelph (CA)

Correspondence Address: SABRE TECHNICAL SERVICES CORP., 4917 N. DAMEN AVE., CHICAGO, IL, 60625, US

(21) Appl. No.: 12/703,820

(22) Filed: Feb. 11, 2010

Related U.S. Application Data
(63) Continuation of application No. 11/767,665, filed on Jun. 25, 2007.
Application No. 11/767,665 is a continuation-in-part of application No. 11/611,880, filed on Dec. 17, 2006.
Application No. 11/611,880 is a continuation of application No. 10/416,099, filed on May 6, 2003, now abandoned.
(60) Provisional application No. 60/265,761, filed on Feb. 1, 2001.

(51) Int. Cl. G01N 21/47; G01N 21/27

(52) U.S. Cl. 356/340

(57) ABSTRACT

Changes in cell parts are assayed by transforming light scattering data from a detection optimized control ensemble of cells and a detection optimized treatment ensemble sample of cells, where the control sample is from a sample and the treatment sample is from the sample with at least one detection agent added, and where the light scattering data have at least a primary assay specific data density in at least a primary assay specific angular range at least partly within zero to four degrees from an incident light central ray.

This application is a continuation in part of co-pending U.S. application Ser. No. 11/767,665 filed 25 Jun. 2007 and published as US2007/0292942A1 on 20 Dec. 2007 which is a continuation in part of U.S. application Ser. No. 11/611,880 filed 17 Dec. 2006 and published as US2007/0105088 on 10 May 2007, which is a continuation of U.S. application Ser. No. 10/416,099 filed 6 May 2003 and published as US2004/0043433 on 4 Mar. 2004, which is a 371 of PCT application PCT/US02/021322 filed 25 Jan. 2002 and published as WO02/077748 on 3 Oct. 2002 which claims priority of U.S. provisional application 60/265,761 filed 1 Feb. 2001, all of which are incorporated in full herein by reference.

The small angle light scattering assay system and the method both execute a profiles transformation so that control profile data and treatment profile data are transformed to assay measures data which reliably and sensitively represent changes in cell parts.

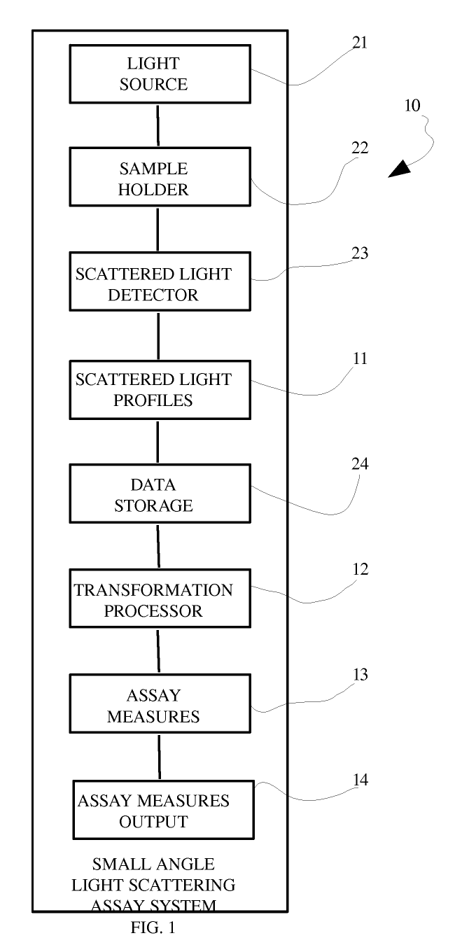

FIG. 1 is a schematic representation of parts of the system 10.

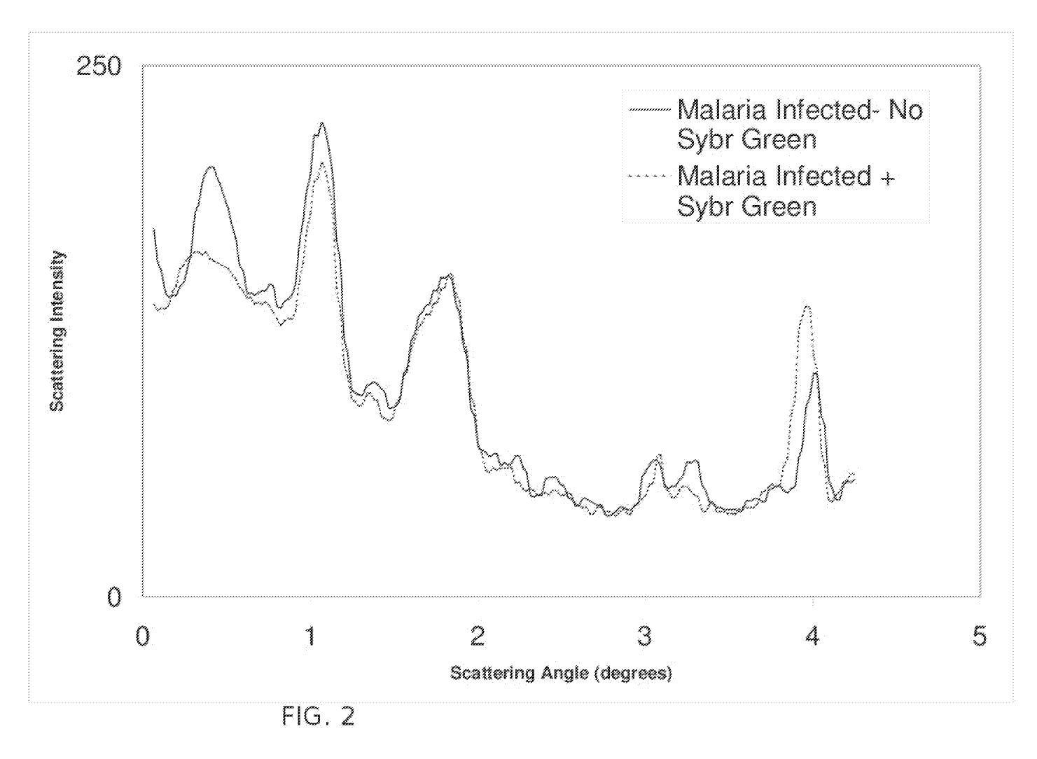

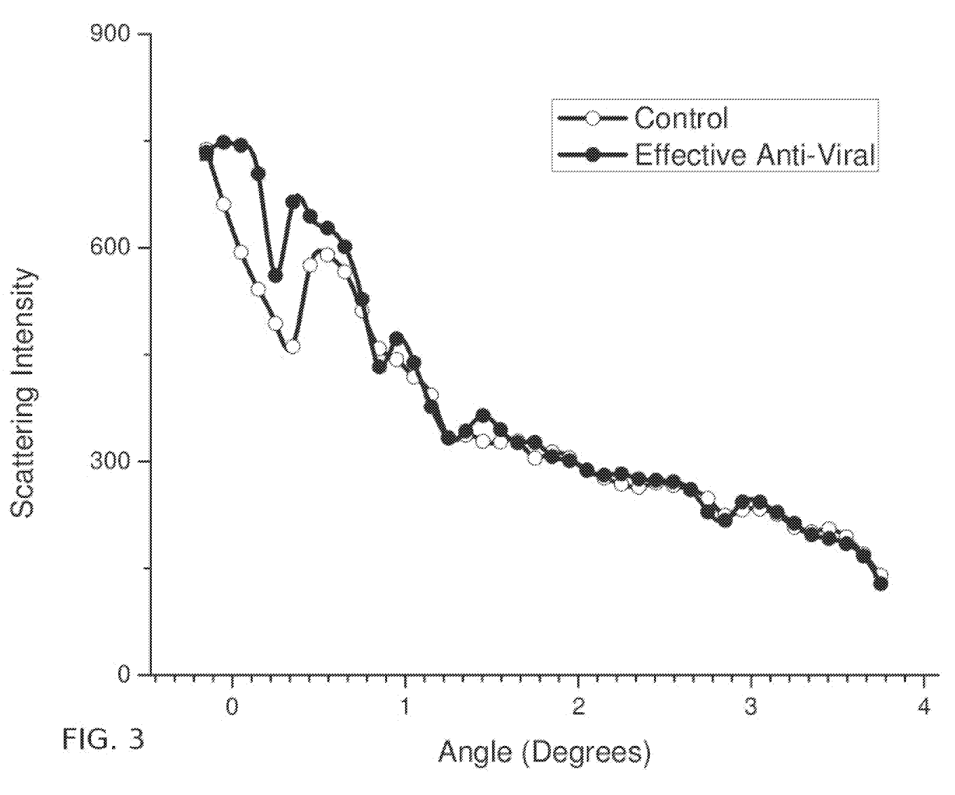

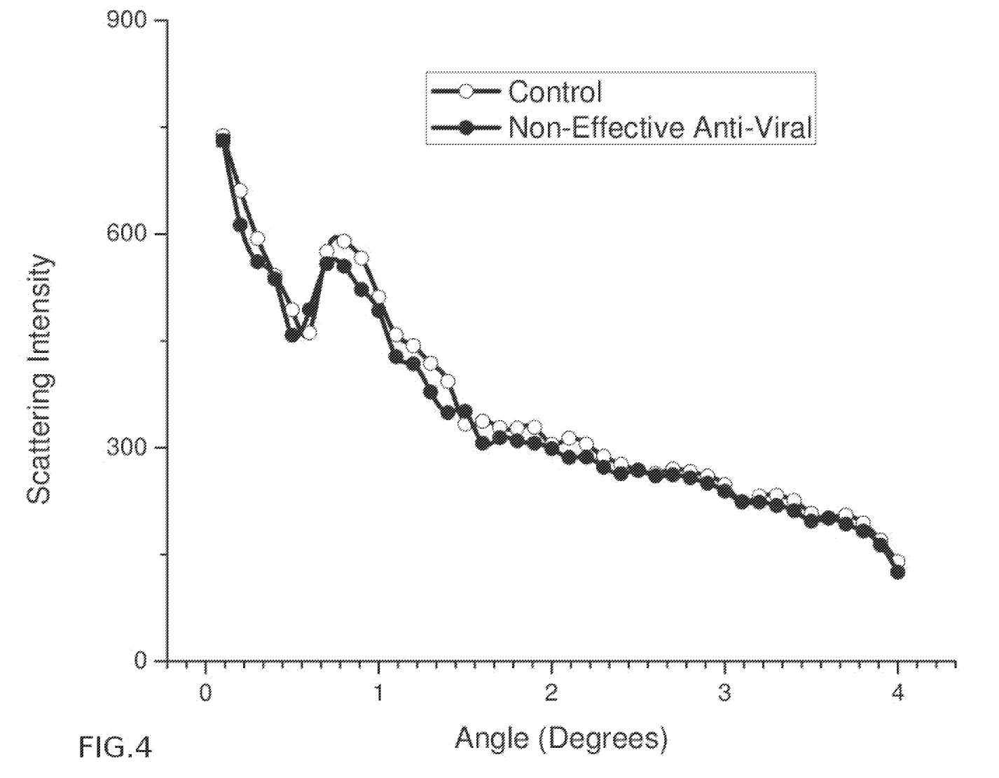

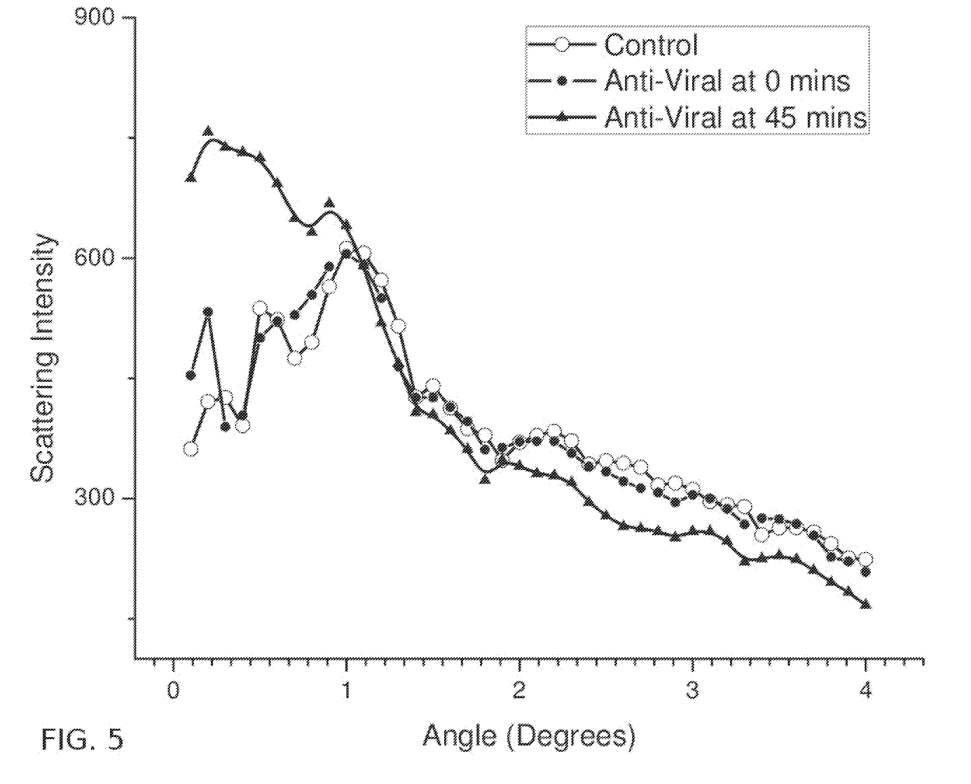

FIG. 2 shows an example of comparison of control profile data (solid curve) and corresponding treatment profile data (dotted curve). This—and FIG. 3, FIG. 4, and FIG. 5—illustrate key features of the system and method: Light scattering by an ensemble of cells in a medium has a rich structure, at least in a primary assay specific angular range at least partly within zero and four degrees. A data density of intensity data points per angle must be great enough to capture details of this structure which results from many scattering phenomena including effects from statistical fluctuations of the ensemble. The profiles transformation can not be enabled without a data density appropriate to the cell parts changes being assayed.

FIG. 3 shows comparison of a virus infected control profile and an effective anti-viral agent treatment profile.

FIG. 4 shows comparison of a virus infected control profile and an ineffective anti-viral agent treatment profile.

FIG. 5 shows comparison of a virus infected control profile and effective anti-viral agent treatment profiles at two times. All of these virus infection comparisons are typical for virus infections in general and are specifically HIV infection.

The system comprises a light source 21 of incident light having a central ray, a sample holder 22, a scattered light detector 23, a data storage device 24, and a transformation processor 12.

The light source, the sample holder, and the scattered light detector are aligned so that the incident light central ray passes through the sample holder and intersects the scattered light detector. The scattered light detector can detect at least a primary assay specific data density of scattered light intensity data points per angle in at least a primary assay specific angular region which is at least partly within zero and four degrees away from the incident light central ray. The primary assay specific data density and primary assay specific angular range are assay members of an assay plurality of assay specific conditions for various assays corresponding to various cell states, various attacking agents, and various detection agents. The assay specific conditions for any assay member of the assay plurality are determined from confirmed historical assay measures data for the assay member. Historical assays measures data are confirmed by comparison with existing best practice.

The scattered light detector outputs scattered light profiles data 11 to the data storage device. The scattered light profiles data comprise control profile data and treatment profile data.

Control profile data represent a control angular distribution of control scattered light intensity. The control profile data have an assay specific data density in an assay specific angular range. Where the assay specific data density and the assay specific angular range are a member of the assay plurality.

Treatment profile data represent a treatment angular distribution of treatment scattered light intensity. Treatment profile data have the assay specific data density.

Control scattered light comprises incident light from the light source scattered by a control ensemble of scatterers in the sample holder. The control ensemble of scatterers comprises cells from a sample. The control ensemble of scatterers has an assay specific detection optimized concentration. The assay specific detection optimized concentration is an assay member of the assay plurality.

Treatment scattered light comprises light from the light source scattered by a treatment ensemble of scatterers in the sample holder. The treatment ensemble of scatterers comprises cells from the sample with at least one detection agent added. The treatment ensemble of scatterers has the detection optimized concentration.

The ensemble of scatterers is detection optimized to a concentration high enough to produce a richly structured profile and low enough so that multiple scattering by each scatterer does not alter the structure to lose reliability and sensitively. For example, for the data represented in FIG. 2 the control sample was nine parts buffer to one part whole blood with the treatment sample having the detection agent added, and with a light path length through the control sample and the treatment sample of 2 mm. The appropriate detection optimized concentration for an assay is determined by confirmed assay measures.

The transformation processor executes a profiles transformation so that control profile data in the data storage device and treatment profile data in the data storage device are transformed to assay measures data 13. The assay measures data represent changes in cell parts. Assay measures data are output by an assay measures output component 14.

A calibration sub-transformation can be a component of the profiles transformation. The calibration sub-transformation can correct for changes not being assayed for caused by the detection agent.

The profiles transformation can comprise superimposed representations of control profile data and treatment profile data for visual inspection.

The profiles transformation can comprise summing absolute values of differences between each control data point in control data and the corresponding treatment data point in the treatment data.

The treatment profile data can have a first component of treatment profile data and a second component of treatment profile data, where the first component and the second component are separated in time. In this case the transformation processor can have a time component which executes a profiles transformation time component so that control profile data in the data storage device, the first component of treatment profile data in the data storage device, and the second component of treatment profile data in the data storage device are transformed to assay measures data.

The control sample can comprise cells from the sample plus at least one detection agent added. This added detection agent can be a detection member from a detection plurality of detection agents. This allows comparisons of combinations of detection agents from the detection plurality.

The sample holder can hold the control sample and alternatively can hold the treatment sample. The sample holder can comprise component sample holders for holding control samples and the treatment sample.

The light source can be incident on a first sample holder component and incident on a second sample holder component alternately; can, using a beam splitter, be incident on component sample holders together; and can have light source components which can be incident on component sample holders together.

The scattered light detector can have scattered light detector components in order to detect scattered light from component sample holders. Light from the light source can be incident on component sample holders and light scattered from those component sample holders can be incident on scattered light detector components together.

Factors determining angles light is scattered into include the wavelength of the incident light and the size of the scatterer. For example, for wavelengths between 750 nm and 1,000 nm, the scattering by an ensemble of scatterers comprising cell parts which are in, and near, this size range is well approximated by Mie scattering. Cell parts changes which are especially interesting occur in cell parts in, and near, this size. Mie scattering from these large cell parts is primarily into an angular range between zero and four degrees away from the incident light central ray. (“Cell parts” herein includes whole cells.)

Incident light scattered away from the central ray comprises superpositions of scattering by whole cells and by parts of cells. Superpositions of scatterings can include also superpositions of various orders of Mie scatterings. All these several superpositions result in structured profiles with one and more peaks. If scatterers in samples have some long range order, then this long range order can also contribute to the profile structure akin to scattering by a lattice.

Changes between control profile data and treatment profile data can be caused by changes in size and shape of scatterers and can be caused by changes in index of refraction of scatterers and of the medium, and can be caused by loss of scatterers. All of these factors are also subject to random variations. Assays work when changes caused by detection agents are reliably and sensitively greater than random variations.

Though the angles at which various size scatterers will scatter is well known, because of the complexity from these many superpositions, because of the complexity from light being scattered by many cell parts, and because of the statistical complexity of scattering by an ensemble of cells in a medium; it was not expected that changes in cell parts caused by detection agents could be reliably and sensitively determined by a light scattering assay.

The inventive step—moving beyond well known features of scattering—comprises extracting information about levels of changes in cell parts from a control profile and a treatment profile.

This inventive step depends on several unexpected discoveries: It is an unexpected discovery that reliable and sensitive information about changes in cell parts can be determined by comparing control profile data and treatment profile data. It is an unexpected discovery that cell part specific changes between control profile data and treatment profile data which are measurably greater than random changes can be reliably and sensitively measured. It is an unexpected discovery that this information is well manifest when the ensemble of scatterers is detection optimized. It is an unexpected discovery that it is not necessary to know in detail the source of the structure of profiles to do this.

These results can only be enabled by measuring light scattering intensity with a sufficient data density. The curves shown in FIG. 2, FIG. 3, FIG. 4, and FIG. 5 represent measurements at each tenth of a degree between zero and four degrees. Without sufficient data density, structures would not be manifest and reliable and sensitive assay information could not be extracted.

Control profile data and treatment profile data herein both necessarily have an assay specific data density in an assay specific angular range needed to achieve useful reliability and sensitivity.

These unexpected discoveries avoid the long troubling need for biochemical assays which are costly and not easy nor quick, and make possible the long-sought goal of easy and rapid and inexpensive assays of changes in cell parts.

When at least some cells in the sample are in a cell state of interest, and when a detection agent can cause a change in a cell part of cells in the cell state of interest, then a profiles transformation which can detect change in the cell part can therefore detect that cells are in the cell state of interest, and alternatively are not in the cell state of interest. The assay measures data thus can represent whether or not cells are in a cell state of interest, can represent level of change of a cell state of interest caused by a detection agent, and can represent the change in a cell part caused by a detection agent.

A cell state of interest can be:
normality,
abnormality (eg cancer),
attacked by an attacking agent,
any state where a detection agent can change a cell part when the cell is in the cell state of interest;

where an attacking agent can be:
virus (eg HIV as in FIG. 3 and FIG. 4),
bacteria,
parasite (eg malaria plasmodium sp as in FIG. 2),
a stressing agent (eg a member of reactive oxygen species)
any agent causing changes in a cell state of interest.

where a detection agent can be:
biologically active (eg an anti-viral agent as in FIG. 3, FIG. 4 and FIG. 5),
not biologically active but interacting with cell parts being assayed (eg stains and dyes as in FIG. 2),
inert,
native to cells being assayed,
not native to cells being assayed,
electric fields,
magnetic fields,
various combinations of these.

The system and method can accomplish various assays corresponding to various cell states, various attacking agents, and various detection agents with the assay plurality specifying conditions corresponding to the various assays.

Profiles transformations and corresponding assay measures data can take many forms.

One form of a profiles transformation can be presentation of superimposed representations of control profile data and treatment profile data for visual inspection of control profile data and treatment profile data as in FIG. 2, FIG. 3, FIG. 4, and FIG. 5.

This form of the profiles transformation can be improved by a calibration sub-transformation. A calibration sub-transformation can be used when a detection agent can cause changes not being assayed for.

A calibration sub-transformation can comprise choosing a calibration angle where changes being assayed for are not manifest and applying a calibration factor so that the control profile and the treatment profile have the same value of intensity at this calibration angle. A calibration sub-transformation has been applied to the curves in FIG. 2, FIG. 3, FIG. 4, and FIG. 5.

Alternatively several calibration angles can be used. These several calibration angles can be an angular calibration sub-region and can be remote from each other.

Another form of a profiles transformation can be summing the absolute values of the intensity differences pixel-by-pixel over an angular region of interest. This sum is the net area between the two curves. This form of a profiles transformation also can be improved by a calibration sub-transformation. This form of profiles transformation and a sub-transformation are detailed in PCT patent application PCT/U.S.09/48356 filed 24 Jun. 2009 which is incorporated herein by reference. This sum can exclude intensity differences equal to and less than random differences.

Another form of a profiles transformation can be the intensity difference at one key angle—and alternatively at more than one key angles—in an assay specific angular region of interest. Again this form of a profiles transformation can be improved by a calibration sub-transformation.

Any profiles transformation, including various statistical techniques, which reliably distinguishes between cell part specific changes caused by the detection agent and random changes can be used. The inventive step comprises extracting from control profile data and treatment profile data information about levels of changes in cell parts.

A profiles transformation can be a combination of more than one component profiles transformations.

A form of profiles transformation can be chosen from various possibilities to represent the information manifest in differences between control profile data and treatment profile data. The form chosen can be matched to the specific cause of abnormality of a cell part and to the specific means of action of a detection agent.

Changes in cell states caused by detection agents can depend on time. In this case treatment profile data can have a first component of treatment profile data and a second component of treatment profile data, where the first component and the second component are separated in time. Then the transformation processor has a time component to execute a time component profiles transformation so that control profile data in the data storage device, the first component of treatment profile data in the data storage device, and the second component of treatment profile data in the data storage device are transformed to assay measures. FIG. 5 shows an example of this. Here it might be possible to use the earliest treatment profile as the control profile.

An assay measure here can comprise time which a cell can resist an attacking agent such as a stressing ROS agent.

1. A small angle light scattering assay system for detecting changes in cell parts, the system comprising:
a light source of incident light having an incident light central ray;
a sample holder;
a scattered light detector,
where the light source, the sample holder, and the scattered light detector are aligned so that the incident light central ray passes through the sample holder and intersects the scattered light detector,
where the scattered light detector can detect at least a primary assay specific data density of scattered light intensity data points per angle in at least a primary assay specific angular region which is at least partly within zero and four degrees away from the incident light central ray,
where the primary assay specific data density and primary assay specific angular range are assay members of an assay plurality of assay specific conditions for various assays corresponding to various cell states, various attacking agents, and various detection agents,
where the assay specific conditions for any assay member of the assay plurality are determined from confirmed historical assay measures data for the assay member,
where historical assays measures data are confirmed by comparison with existing best practice;
a data storage device;
where the scattered light detector inputs profiles data to the data storage device, the profiles data comprising control profile data and treatment profile data,
where control profile data represent a control angular distribution of control scattered light intensity and where the control profile data have an assay specific data density in an assay specific angular range,
where the assay specific data density and the assay specific angular range are a member of the assay plurality.
where treatment profile data represent a treatment angular distribution of treatment scattered light intensity and where treatment profile data have the assay specific data density in the assay specific angular range,
where control scattered light comprises incident light from the light source scattered by a control ensemble of scatters in the sample holder, the control ensemble of scatterers comprising cells from a sample, the control ensemble of scatterers having an assay specific detection optimized concentration,
where the assay specific detection optimized concentration is an assay member of the assay plurality,
where treatment scattered light comprises light from the light source scattered by a treatment ensemble of scatterers in the sample holder, the treatment ensemble of scatterers comprising cells from the sample with at least one detection agent added, the treatment ensemble of scatterers having the detection optimized concentration; and
a transformation processor,
where the transformation processor executes a profiles transformation so that control profile data and treatment profile data are transformed to assay measures data, the assay measures data representing changes in cell parts.

2. The system of claim 1 where a calibration sub-transformation is a component of the profiles transformation, the calibration sub-transformation correcting for changes not being assayed for caused by the detection agent.

3. The system of claim 1 where the profiles transformation comprises presenting superimposed representations of control profile data and treatment profile data for visual inspection.

4. The system of claim 1 where the profiles transformation comprises summing absolute values of differences between each control data point in control data and the corresponding treatment data point in the treatment data.

5. The system of claim 1 where the treatment profile data have a first component of treatment profile data and a second component of treatment profile data, where the first component and the second component are separated in time, and where the transformation processor has a time component which executes a profiles transformation time component so that control profile data in the data storage device, the first component of treatment profile data in the data storage device, and the second component of treatment profile data in the data storage device are transformed to assay measures data.

6. A small angle light scattering assay method for detecting changes in cell parts, the method comprising:
illuminating a sample holder with incident light from a light source, the incident light having a central ray;
detecting scattered light from the sample holder with a scattered light detector,
where the light source, the sample holder, and the scattered light detector are aligned so that the incident light central ray passes through the sample holder and intersects the scattered light detector,
where the scattered light detector can detect at least a primary assay specific data density of scattered light intensity data points per angle in at least a primary assay specific angular region which is at least partly within zero and four degrees away from the incident light central ray,
where the primary assay specific data density and primary assay specific angular range are assay members of an assay plurality of assay specific conditions for various assays corresponding to various cell states, various attacking agents, and various detection agents,
where the assay specific conditions for any assay member of the assay plurality are determined from confirmed historical assay measures data for the assay member,
where historical assays measures data are confirmed by comparison with existing best practice;
inputing by the scattered light detector of profiles data to a data storage device,
where the profiles data comprise control profile data and treatment profile data,
where control profile data represent a control angular distribution of control scattered light intensity and where the control profile data have an assay specific data density of intensity data points per angle in an assay specific angular range,
where the assay specific data density and the assay specific angular range are a member of the assay plurality.
where treatment profile data represent a treatment angular distribution of treatment scattered light intensity and where treatment profile data have the assay specific data density in the assay specific angular range,
where control scattered light comprises incident light from the light source scattered by a control ensemble of scatters in the sample holder, the control ensemble of scatterers comprising cells from a sample, the control ensemble of scatterers having an assay specific detection optimized concentration,
where the assay specific detection optimized concentration is an assay member of the assay plurality,
where treatment scattered light comprises light from the light source scattered by a treatment ensemble of scatterers in the sample holder, the treatment ensemble of scatterers comprising cells from the sample with at least one detection agent added, the treatment ensemble of scatterers having the detection optimized concentration; and
transforming profiles data with a transformation processor which executes a profiles transformation so that control profile data and treatment profile data are transformed to assay measures data, the assay measures data representing changes in cell parts,

7. The method of claim 6 where the transforming step has a calibrating component, where the calibrating component comprises a calibration sub-transformation, the calibration sub-transformation correcting for changes not being assayed for caused by the detection agent.

8. The method of claim 6 where the transforming step has a presenting component comprising presenting superimposed representations of control profile data and treatment profile data for visual inspection.

9. The method of claim 6 where the transforming step has an area calculating component comprising summing absolute values of differences between each control data point in control data and the corresponding treatment data point in treatment data.

10. The method of claim 6 where the inputting step has a time inputing component comprising inputing a first component of treatment profile data and a second component of treatment data, where the first component and the second component are separated in time, and where the transforming step has a time component for executing a time component profiles transformation so that control profile data in the data storage device, the first component of treatment profile data in the data storage device, and the second component of treatment profile data in the data storage device are transformed to assay measures.
